(19) United States
(12) Patent Application Publication
(10) Pub. No.: US 2007/0256532 A1
(43) Pub. Date: Nov. 8, 2007

(54) Drum made of environment friendly materials

(76) Inventor: Shih-Ying Lu, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/417,104

(22) Filed: May 4, 2006

(51) Int. Cl. B32B 27/08

(52) U.S. Cl. 84/1; 428/35.7

(57) ABSTRACT

A drum includes a shell, which is made of environment friendly materials such as polyethylene terephthalate (PET), Polycarbonate (PC), Polystyrene (PS), and Polypropylene (PP); furthermore, after shaping, the drum shell is printed, plated, and decorated with stickers on the surface so as to be bright-colored and capable of varying in colors.

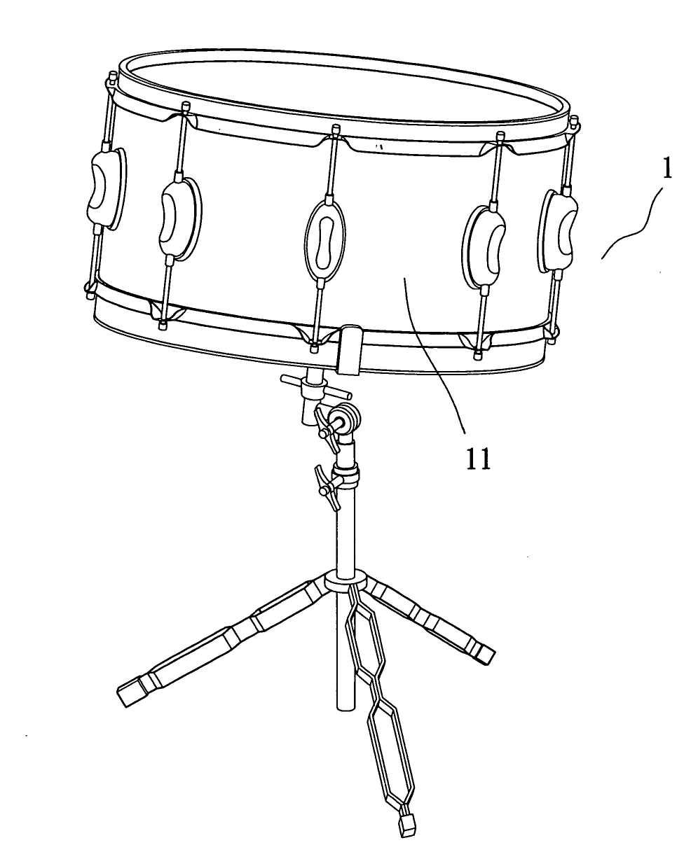

### BACKGROUND OF THE INVENTION

1. Field of the Invention

The present invention relates to a drum made of environment friendly materials, more particularly one, which includes a shell made of environment friendly and recyclable materials such as polyethylene terephthalate (PET), Polycarbonate (PC), Polystyrene (PS), and Polypropylene (PP); the above materials won't release dioxin when burnt.

2. Brief Description of the Prior Art

The plastic industry is prosperous currently because plastics have excellent plasticity and can be efficiently mass-produced. Most appliances include parts made of plastic materials. Among various plastic materials, PVC (polyvinyl chloride) was developed very early, and is currently used for a wide range of applications. The amount of PVC produced and used is increasing world wide because PVC has the major advantages of plastics such as plasticity, and is easy to process, inexpensive. PVC is majorly used as the materials of non-foods such as water pipes, raincoats, schoolbags, building materials, plastic films, plastic boxes, and jazz drum shells.

PVC is used as the material of drum shells because it has good transparency, water resistibility, and insulating ability, and can be mass-produced at relatively low cost. However, PVC has its disadvantages; the major disadvantages of PVC are relatively low impact strength, poor cold-resistibility, and possessing a relatively low heat distortion point, and being easily scratched or marred. Furthermore, PVC is a polymer of ethylene chloride, which will release bad-smelling gas and cancer-causing dioxin when burnt. Therefore, use of PVC could be harmful to the environment.

### SUMMARY OF THE INVENTION

It is a main object of the invention to provide a drum made of environment friendly materials to overcome the above-mentioned problems. The drum of the present invention includes a shell, which is made of environment friendly materials such as polyethylene terephthalate (PET), Polycarbonate (PC), Polystyrene (PS), and Polypropylene (PP). Furthermore, the drum shell is, after shaping, printed, plated, and decorated with stickers on the surface so as to be bright-colored and capable of varying in colors.

### BRIEF DESCRIPTION OF THE DRAWINGS

The present invention will be better understood by referring to the accompanying drawing:

The FIGURE is a perspective view of a drum made of environment friendly materials in the present invention.

### DETAILED DESCRIPTION OF THE PREFERRED EMBODIMENTS

Referring to the Fig. using a jazz drum 1 as the example, a preferred embodiment of a drum made of environment friendly materials includes a shell 11, which can be made of polyethylene terephthalate (PET), Polycarbonate (PC), Polystyrene (PS) or Polypropylene (PP), which have the following characters respectively:

1. PET is acid-resistant, alkaline-resistant, and incapable of being resistant to a high temperature, and has high transparency.

2. PP is glossy, light in weight, and resistant to 93 to 160° C.

3. PS has excellent size-stability, and is resistant to 60 to 80° C.

4. PC has high transparency, high toughness, high impact strength, size-stability, and is resistant to 121° C.

Furthermore, it won't produce toxic substance or toxic gas to burn polyethylene terephthalate (PET), Polycarbonate (PC), Polystyrene (PS), and Polypropylene (PP).

Therefore, the drum shell 11 of the present invention is glossy, transparent, and will be bright-colored after it surface is printed.

From the above description, it can be seen that the environment friendly drum of the present invention has the following advantages:

1. The shell of the drum is made of no-toxic materials therefore no toxic substance will be produced when the shell is burnt.

2. The shell of the drum has a hard surface, and is resistant to wear and scratch.

3. The surface of the shell of the drum will be bright-colored if it is printed properly.

4. The surface of the shell of the drum will be bright-colored and capable of varying in its colors if it is plated properly and decorated with stickers.

What is claimed is:

1. A drum made of environment friendly materials, comprising
a shell made of environment friendly plastic materials that won't release dioxin when burnt, said environment friendly plastic materials being polyethylene terephthalate (PET).

2. The drum made of environment friendly materials as recited in claim 1, wherein said environment friendly plastic materials are Polycarbonate (PC).

3. The drum made of environment friendly materials as recited in claim 1, wherein said environment friendly plastic materials are Polystyrene (PS).

4. The drum made of environment friendly materials as recited in claim 1, wherein said environment friendly plastic materials are Polypropylene (PP).
